(19) United States
(12) Patent Application Publication
(10) Pub. No.: US 2016/0125095 A1
(43) Pub. Date: May 5, 2016

(54) LIGHTWEIGHT TEMPORAL GRAPH MANAGEMENT ENGINE

(71) Applicant: NEC Laboratories America, Inc., Princeton, NJ (US)

(72) Inventor: Fengyuan Xu, Franklin Park, NJ (US)

(21) Appl. No.: 14/932,873

(22) Filed: Nov. 4, 2015

Related U.S. Application Data
(60) Provisional application No. 62/075,327, filed on Nov. 5, 2014.

(51) Int. Cl. G06F 17/30

(52) U.S. Cl. CPC G06F 17/30958; G06F 17/30321; G06F 17/30598; G06F 17/30979

(57) ABSTRACT

A method and system are provided. The method includes storing, in a memory, temporal data for a temporal graph. The memory includes a temporal graph storage structure having a set of buckets. The temporal data stored in the buckets includes respective data segments implemented using graph edges. Each of the graph edges has a start time and an end time associated therewith. The method further includes the methods, performed by a processor, of: forming an index that categorizes the graph edges based on the end times of the graph edges; positioning the graph edges within respective ones of the buckets for storage using the index such that the graph edges are positioned in the respective ones of the buckets in a chronological order that is based on the end times; and accessing the temporal graph storage structure using the index responsive to a temporal graph query.

### BACKGROUND

1. Technical Field

The present invention relates to temporal graph generation and, in particular, to a lightweight temporal graph management engine.

2. Description of the Related Art

Temporal data is ubiquitous in the real world, being used to create transportation data, communication data, internet data, etc. A temporal graph is a directed graph with time information on edges. Temporal graphs can be used to represent a number of diverse applications, such as network traffic, human activities, transportation, and in other applications where edges appear and disappear at different time instants. This data representation can capture complicated relationships over evolving dynamic systems and can be used as an input to a number of data analysis methods.

Compared to static graphs, in a temporal graph there are three unique aspects that play an important role in data analytics: temporal duration; temporal dynamics; and temporal order. Unfortunately, existing temporal graph systems offer efficient computation mostly for snapshot retrieval and cannot efficiently support temporal period analytical queries or temporal ordering analytical queries. Furthermore, existing temporal graph systems require considerable infrastructure and resources, even for use with medium-sized temporal graph data.

### SUMMARY

A method is provided. The method includes storing, in a memory, temporal data for a temporal graph. The memory includes a temporal graph storage structure having a set of buckets. The temporal data stored in the buckets includes respective data segments implemented using graph edges. Each of the graph edges has a start time and an end time associated therewith. The method further includes forming, by a processor, an index that categorizes the graph edges based on the end times of the graph edges. The method also includes positioning, by the processor, the graph edges within respective ones of the buckets for storage using the index such that the graph edges are positioned in the respective ones of the buckets in a chronological order that is based on the end times. The method additionally includes accessing, by the processor, the temporal graph storage structure using the index responsive to a temporal graph query.

A system is provided. The system includes a memory for storing temporal data for a temporal graph using a temporal graph storage structure having a set of buckets. The temporal data stored in the buckets includes respective data segments implemented using graph edges. Each of the graph edges has a start time and an end time associated therewith. The system further includes a processor configured to form an index that categorizes the graph edges based on the end times of the graph edges. The processor is also configured to position the graph edges within respective ones of the buckets for storage using the index such that the graph edges are positioned in the respective ones of the buckets in a chronological order that is based on the end times, The processor is additionally configured to access the temporal graph storage structure using the index responsive to a temporal graph query.

These and other features and advantages will become apparent from the following detailed description of illustrative embodiments thereof, which is to be read in connection with the accompanying drawings.

### BRIEF DESCRIPTION OF THE DRAWINGS

FIG. 1 is a block diagram describing an exemplary processing system 100 to which the present principles may be applied, according to an embodiment of the present principles;

FIG. 2 is a block diagram showing a lightweight temporal graph management engine 200, in accordance with the present principles;

FIG. 3 is a flowchart showing a process 300 of the temporal graph management engine, in accordance with the present principles; and

FIG. 4 shows a system 400 for performing temporal analytics, in accordance with the present principles.

### DETAILED DESCRIPTION OF PREFERRED EMBODIMENTS

In accordance with the present principles, systems and methods are provided for managing large-scale temporal graphs by employing a lightweight temporal graph management engine. To support advanced temporal graph analytic tasks, the lightweight temporal graph management engine provides at least the following three basic operations: temporal duration snapshot retrieval; temporal delta retrieval; and temporal path discovery. These operations can be used as building blocks for various complicated temporal graph analytics. Of course, other operations can also be used in accordance with the teachings of the present principles, while maintaining the spirit of the present principles. The temporal graph management engine further has the capability to handle large-scale graphs using commodity hardware. This allows even a casual user to perform basic data analytics processing without the need to acquire expensive or complicated infrastructure. As used herein, the term “temporal graph management engine” refers to an implementation of the present principles that involves at least a processor and a memory. The term “temporal graph management engine” can be interchangeably referred to herein as a “T-Graph engine.”

Advantageously, the T-Graph engine can be lightweight for large-scale, real-world temporal graphs. The T-Graph engine can be implemented on a single node disk-based system and can focus on time-locality queries. Furthermore, the T-Graph engine supports three types of queries: temporal duration snapshots queries; temporal duration delta queries; and temporal path discovery queries. Moreover, the T-Graph engine defines three snapshot retrieval types (a covering type, an existing type, and a persisting snapshot type) to enhance the rich analytics of temporal graphs.

Additionally, the T-Graph engine includes a partial order edge list as a storage structure and builds indexes on top of the storage structure. This can efficiently conduct all proposed time-locality queries on temporal graphs. The storage structure and index structure are space-efficient and the query methods are time-efficient and scalable. Furthermore, the T-Graph engine is able to manage real-world datasets, ranged from millions of edges to billions of edges, on just a single commodity machine.

Advantageously, the T-Graph engine requires relatively small storage space for persisting large and complex temporal graphs.

Advantageously, the T-Graph engine can quickly search and derive queried graph snapshots from the large graph dataset with limited computation resources.

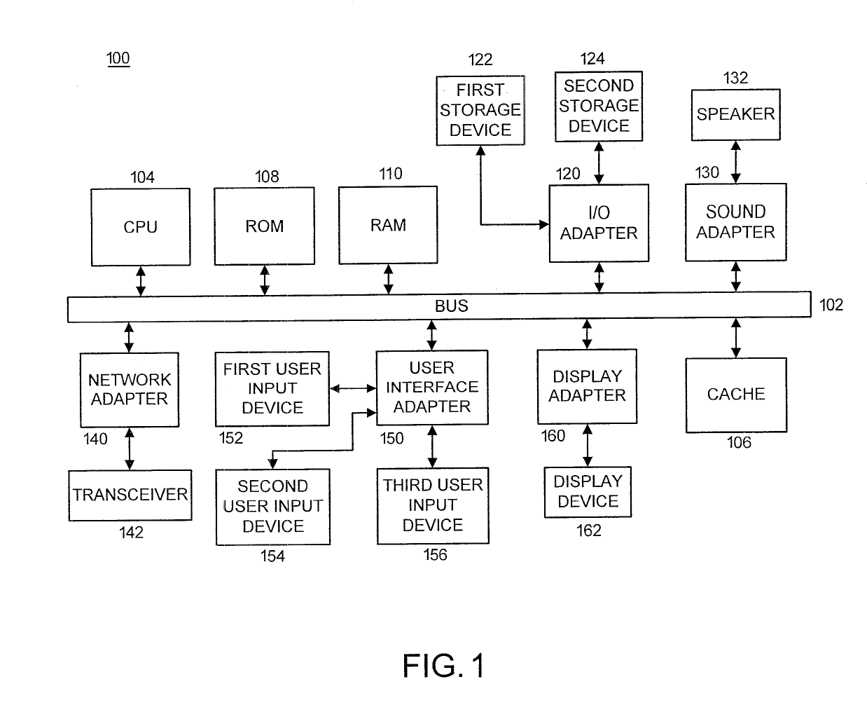

Referring to the drawings in which like numerals represent the same or similar elements and initially to FIG. 1, a block diagram describing an exemplary processing system 100 to which the present principles may be applied is shown, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to a system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to the system bus 102 by the sound adapter 130. A transceiver 142 is operatively coupled to the system bus 102 by a network adapter 140. A display device 162 is operatively coupled to the system bus 102 by a display adapter 160. A first user input device 152, a second user input device 154, and a third user input device 156 are operatively coupled to the system bus 102 by a user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used while maintaining the spirit of the present principles. The user input devices 152, 154, and 156 can be the same type of user input device or different types of user input devices. The user input devices 152, 154, and 156 are used to input and output information to and from the system 100.

Of course, the processing system 100 may also include other elements (not shown), as readily contemplated by one of skill in the art, as well as omit certain elements. For example, various other input devices and/or output devices can be included in the processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations, can also be utilized as readily appreciated by one of ordinary skill in the art. These and other variations of the processing system 100 are readily contemplated by one of ordinary skill in the art given the teachings of the present principles provided herein.

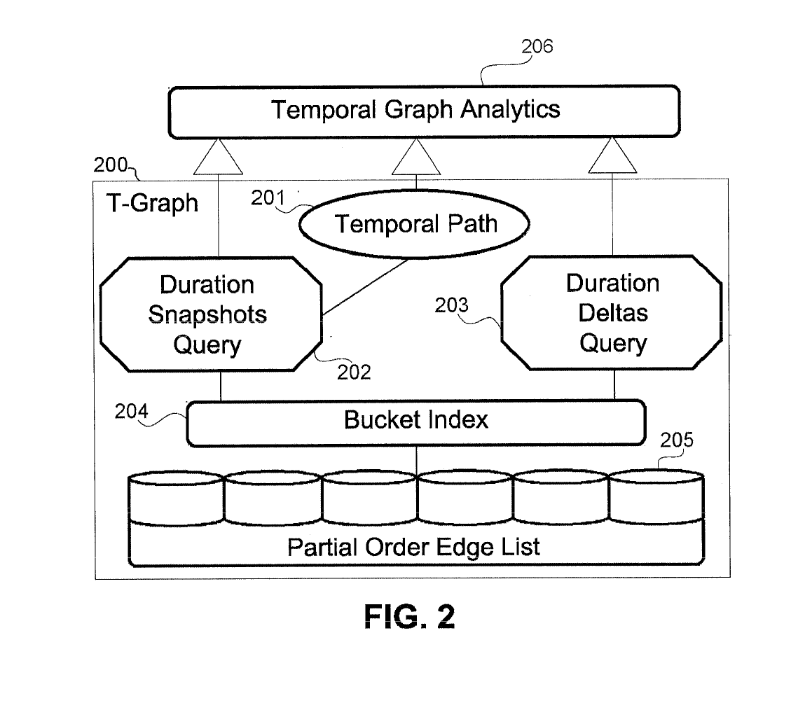

Referring now to FIG. 2, an exemplary functional block diagram of a T-Graph engine 200 is shown in accordance with the present principles.

The T-Graph engine 200 can include, and/or otherwise interface with, a graph storage structure 205, an index structure 204, indexing methods, and query methods. The query methods can include: a temporal duration snapshots query 202; a temporal duration deltas query 203; and a temporal path query 201. Together, these components can serve a broad range of temporal graph analytics 206. Existing graph methods on static graphs or incremental graph methods can work without modification on top of the T-Graph engine 200. In the T-Graph engine 200, the graph storage structure 205 is represented by a partial order edge list 205, and a bucket index 204 can be built on top of the partial order edge list 205. Three sets of querying methods, namely methods for conducting temporal path queries 201, duration snapshots queries 202, and duration deltas queries 203, are combined with index methods on the bucket index 204 and partial order edge list 205.

Advantageously, by forming the partial order edge list 205 as the temporal graph storage structure 205, the benefits of a time-locality search, as implemented by the duration snapshots query 202 and duration deltas query 203, are maximized. In the partial order edge list 205, each bucket can have the same storage space but the lengths of time duration for different buckets may not be equal. The buckets are indexed into a bucket index 204 which is built on top of the partial order edge list 205. Every edge is allocated into exactly one bucket. More formally, for any edge e∈E_{T}, if e∈bᵢ, tₛ(bᵢ)≦tₛ(e)≦tₑ(bᵢ) must hold. In order to save storage space, the edges inside each bucket are in chronologically descending order based on the ending time tₑ(e) of each of the edges to avoid the necessity for the inclusion of explicit indexing. In other embodiments, a chronologically ascending order can be used.

There are two kinds of queries inside each bucket: an upper-edge query, which retrieves all edges in the specific bucket with ending times larger or equal to a given time, and a lower-edge query that gives all edges in the specific bucket with ending times less or equal to a given time. Such upper-edge query and lower-edge query can be computed efficiently (O(log k)) by using the aforementioned inner order of each bucket.

In the embodiment, nodes are kept in a set. There is no connecting information for the set. The connecting information of the temporal graph is stored only in the partial chronological order edge list 205. The partial order edge list 205 is partitioned into a sequence of buckets B={bᵢ|1≦i≦|B|}. Each bucket bᵢ maintains k edges. For each bucket bᵢ, there are two types of time information: bucket start time tₛ(bᵢ); and bucket end time tₑ(bᵢ), where tₛ(bᵢ)≦tₑ(bᵢ). For two consecutive buckets, bᵢ and bᵢ₊₁, tₑ(bᵢ) holds. Storage space for each bucket can be the same, but lengths of time duration for different buckets may not be equal. In the partial order edge list 205, every edge is allocated into exactly one bucket. For any edge e∈E_{T}, if e∈bᵢ, tₛ(bᵢ)≦tₛ(e)≦tₑ(bᵢ) must hold.

TABLE 1 describes an example of a bucket structure.

TABLE 1

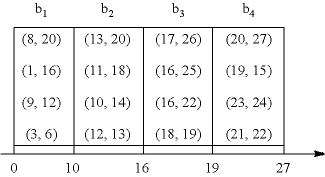

For the purposes of TABLE 1, assume that the time range for the entire temporal graph is [0,27] and that there are a total of 16 temporal edges. Each bucket maintains 4 edges. Therefore, there are 4 buckets. In this example, a temporal edge is represented as a pair of two numbers: the starting time of the edge; and the ending time of the edge. Here, other information about the edges, such as the source node and the destination node, is omitted. The temporal edges are allocated to buckets based on the starting time tₛ(e). The first four edges with the earliest starting times are allocated to bₗ. The starting times in bₗ are 1, 3, 8, and 9. However, inside the bucket, the edges are in descending order based on the ending time tₑ(e). The edge with the largest ending time is the first edge in the bucket. Therefore, in bucket bₗ, the temporal edges are ordered as (8,20), (1,16), (9,12), and (3,6).

The partial order edge list 205 can easily handle newly incoming data of temporal graphs. When a new edge is incoming, the starting time of the new edge must be the largest. Then, if the rightmost bucket is not full, the new edge will be filled into the rightmost bucket at a proper position (using a binary search on the edge ending time) and the ending time of the rightmost bucket will be updated. Otherwise, a new bucket will be generated and the new edge will be put into the new bucket. The time complexity of inserting a new edge will be O(log k), where k is the size of the bucket, which is a constant.

In one embodiment, removing temporal edges from the partial order edge list 205 is not considered. All historical temporal edges in the partial order edge list 205 are kept. However, if some edges need to be permanently removed, those edges can be marked so that they can be skipped during a query.

Methods for retrieving temporal duration snapshots are now described. Let the given time duration be [tₓ, t_{y}]. For a covering snapshot CS(tₓ, t_{y}), if the temporal edge e satisfies tₛ(e)≧tₓ and tₑ(e)≦t_{y}, then edge e should belong to CS. Similarly, if the temporal edge e satisfies tₛ(e)≦tₓ and tₑ(e)≧t_{y}, then edge e should belong to the persisting snapshot PS(tₓ, t_{y}). Finally, when the temporal edge e satisfies tₛ(e)≦t_{y} and tₑ(e)≧tₓ, then edge e should belong to the existing snapshot ES(tₓ, t_{y}).

According to the above duration snapshots definitions, a two-step approach to retrieve those duration snapshots can be utilized. The first step is to acquire bucket candidates. Here, the bucket candidates are defined as a consecutive sequence of buckets which includes all potential edges in the temporal duration snapshot with a minimal number of buckets. Let bucket candidates be C_{b}={bᵢ, bᵢ₊₁, bᵢ₊₂, . . . , bⱼ}, where the bucket sequence starts from the ith bucket bᵢ to the jth bucket bⱼ. The bucket candidates can be acquired by using an upper-bound bucket query and a lower-bound bucket query associated with the index on top of the buckets. After retrieving the bucket candidates, the second step of temporal duration snapshots retrieval involves checking edges inside each bucket of the bucket candidates. Although different types of duration snapshots have different criteria on checking temporal edges, to verify whether an edge belongs to a duration snapshot or not, checking the edges in each bucket one by one is not needed. Instead, by using upper-edge queries and lower-edge queries, the duration snapshots can be retrieved efficiently in sub-linear time. Hereinafter, details about how to retrieve a covering snapshot, a persisting snapshot, and an existing snapshot by using the two-step approach are described.

For a covering snapshot, the bucket candidates start from MO, which is a lower-bound bucket on time tₓ, and ends at bᵤ(t_{y}), which is the upper-bound bucket on time t_{y}. The eligible edges for the covering snapshot must be in the bucket candidates. Other buckets cannot have any edge that belongs to the covering snapshot. For the second step, let bₖ be a bucket with start time tₛ(bₖ)≧tₓ. All edges in bucket bₖ must have a starting time of no less than tₓ. Therefore, a lower-edge query on bucket bₖ with time t_{y} can be conducted. Since the edges inside the bucket are ordered by ending time, the lower-edge query returns all edges in bₖ with an ending time of no larger than t_{y}, which should belong to the covering snapshot. The bucket start time monotonically increases. All buckets from bₖ to the last bucket in the bucket candidates can be examined by using the lower-edge query. Usually, only the first bucket in a set of the bucket candidates needs a sequential check. All other buckets can be done in logarithmic time.

For a persisting snapshot, the bucket candidates theoretically should start from bₗ and end at bᵤ(tₓ), which is the upper-bound bucket at time tₓ. However, for real-world temporal graphs, the edge duration has certain distributions. Most edges are relatively small and, compared to the entire time length of the temporal graph, the edge duration is even smaller. Under such distributions, the bucket candidates do not need to always start from the first bucket bₗ. If the maximal edge duration is dₘₐₓ, the bucket candidates could start from bₗ(t_{y}−dₘₐₓ), which is the lower-bound bucket at time t_{y}−dₘₐₓ. All buckets before this lower-bound bucket cannot have any edge with an ending time less than t_{y}. In the second step, let bₖ be a bucket with end time tₑ(bₖ)≦tₓ. Then, all edges in bₖ must have a starting time no larger than tₓ. An upper-bound query can be conducted with time t_{y} to return all edges in bₖ with an ending time no less than t_{y}, which belongs to the persisting snapshot. Since the bucket end time also monotonically increases, all buckets from the first bucket of the bucket candidates to bₖ can be checked by using an upper-edge query. Similarly, only the first bucket in the bucket candidates usually needs a sequential check. All other buckets can be done in logarithmic time.

For an existing snapshot, the bucket candidates theoretically start from bₗ but end at bᵤ(t_{y}), which is the upper-bound bucket at time t_{y}. Similar to the persisting snapshot, when the maximal edge duration is dₘₐₓ, the bucket candidates could start from bₗ(tₓ−dₘₐₓ). Different from the covering snapshot and persisting snapshot, the second step of the existing snapshot has three situations.

In the existing snapshot retrieval, some buckets from the bucket candidates do not need any checks. Let bₖ be a bucket with start time tₛ(bₖ)≦tₓ and end time tₑ(bₖ)≦t_{y}. All edges in bₖ should belong to the existing snapshot. There exists another special bucket bᵤ(tₓ), which is the upper-bound bucket at time tₓ. From the first bucket in the bucket candidates to bᵤ(tₓ), an upper-edge query is used to acquire the edges with ending time no less than tₓ. From the bucket after bᵤ(tₓ) to the bucket before the last bucket in the set of bucket candidates, these buckets do not need to be checked because all edges in these buckets belong to the existing snapshot.

According to the above methods, a query on buckets is performed and the bucket candidates are acquired. After that, for different buckets, a sequential scan, binary search, or skip operations is conducted.

TABLE 2 describes three types of temporal duration snapshots with time constraints: the covering snapshot; the persisting snapshot; and the existing snapshot.

TABLE 2

| | | |
|---|---|---|
| Covering Snapshot | Persisting Snapshot | Existing Snapshot |
| 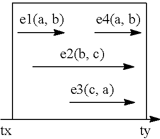 | 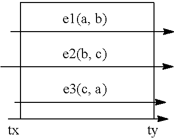 | 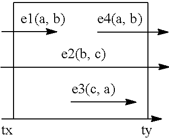 |

All of the temporal snapshots should be associated with some time duration. For a temporal graph G_{T}(V, E_{T}), the covering snapshot, persisting snapshot, and existing snapshot associated with time duration [tₓ, t_{y}], are CS(tₓ, t_{y}), PS(tₓ, t_{y}) and ES(tₓ, t_{y}), respectively.

In the covering snapshot, all edges in the snapshot start, to be active, and end, to be inactive, inside a given time duration [tₓ, t_{y}]. Then CS(tₓ, t_{y})=G_{T}(V, E_{CS}), where E_{CS} ⊂E_{T} and ∀e∈E_{T}, if tₛ(e)≧tₓ and tₑ(e)≦t_{y} [symbol] e∈E_{CS}.

In a persisting snapshot, all edges in the snapshot are always active during an entire given time duration [tₓ, t_{y}]. Let PS(tₓ, t_{y})=G_{T}(V, E_{ES}), where E_{ES} ⊂E_{T} and ∀e∈E_{T}, if tₛ(e)≦tₓ and tₑ(e)≧t_{y} [symbol] e∈E_{PS}.

In an existing snapshot, all edges in the snapshot should be active at least at some time stamp in a given time duration [tₓ, t_{y}]. Let ES(tₓ, t_{y})=G_{T}(V, E_{ES}), where E_{ES} ⊂E_{T} and ∀e∈E_{T}, if tₛ(e)≦t_{y} and tₑ(e)≧tₓ [symbol] e∈E_{ES}.

Let the given time duration be [tₓ, t_{y}] and the shifting time be Δ. Each duration delta includes an adding delta and a removing delta. Moreover, for different types of duration snapshots, there exists a covering delta, a persisting delta, and an existing delta. TABLE 3-a summarizes the definitions of all 6 duration deltas: a covering adding delta; a covering removing delta; a persisting adding delta; a persisting removing delta; an existing adding delta; and an existing removing delta.

TABLE 3-a
Snapshots and Delta Definitions

| Covering Snapshot | | ∀e, tₛ(e) ≧ tₓ & tₑ(e) ≦ t_{y} |
|---|---|---|
| Persisting Snapshot | | ∀e, tₛ(e) ≦ tₓ & tₑ(e) ≧ t_{y} |
| Existing Snapshot | | ∀e, tₛ(e) ≦ t_{y} & tₑ(e) ≧ tₓ |
| Covering | Adding | ∀e, tₛ(e) ≧ tₓ + Δ & tₑ(e) ≧ t_{y} & tₑ(e) ≦ t_{y} + Δ |
| Delta | Removing | ∀e, tₛ(e) ≦ tₓ + Δ & tₑ(e) ≧ tₓ & tₑ(e) ≦ t_{y} |
| Persisting | Adding | ∀e, tₛ(e) ≦ tₓ + Δ & tₑ(e) ≧ tₓ & tₑ(e) ≧ t_{y} + Δ |
| Delta | Removing | ∀e, tₛ(e) ≦ tₓ & tₑ(e) ≧ t_{y} & tₑ(e) ≦ t_{y} + Δ |
| Existing | Adding | ∀e, tₛ(e) ≦ t_{y} + Δ & tₛ(e) ≧ t_{y} & tₑ(e) ≧ tₓ + Δ |
| Delta | Removing | ∀e, tₛ(e) ≦ t_{y} & tₑ(e) ≧ tₓ & tₑ(e) ≦ tₓ + Δ |

For each delta defined above, a two-step approach for retrieval can be utilized. This two-step approach encompasses acquiring bucket candidates and checking the edges inside each bucket of bucket candidates. Different from duration snapshots retrieval, in the first step, all 6 types of duration deltas need to conduct only one upper-bound bucket query and one lower-bound bucket query. While, in the second step, the pruning criteria can be various. Similar to duration snapshot retrieval, the checking step mainly utilizes upper-edge and lower-edge queries for each bucket, which is in logarithmic time.

Details of the bucket candidates for each duration delta and checking operations for each bucket are now described. TABLE 3-b shows the details of the bucket candidates and edge checking operations for both the duration snapshots query 202 and the duration deltas query 203.

TABLE 3-b
Bucket Candidates and Edge Operations
for Duration Snapshots and Deltas

| | | First | Last | | | |
|---|---|---|---|---|---|---|
| | | Bucket | Bucket | Operations | | |
| Covering Snapshot | | bₗ(tₓ) | bᵤ(t_{y}) | Scan b₀ | Search b₁→bₖ | |
| Persisting Snapshot | | bₗ(t_{y} − ε) | bᵤ(tₓ) | Scan bₖ | Search b₀→bₖ₋₁ | |
| Existing | Snapshot | bₗ(tₓ − ε) | bᵤ(t_{y}) | Scan bₖ | Search b₀→b_{k′} | Include b_{k′+1}→bₖ₋₁ |
| Covering | Adding | bₗ(tₓ + Δ) | bᵤ(t_{y} + Δ) | Scan b₀ | Search b₁→bₖ | |
| Delta | Removing | bₗ(tₓ) | bᵤ(tₓ + Δ) | Scan b₀, bₖ | Search b₁→bₖ₋₁ | |
| Persisting | Adding | bₗ(tₓ) | bᵤ(tₓ + Δ) | Scan b₀, bₖ | Search b₁→bₖ₋₁ | |
| Delta | Removing | bₗ(t_{y} − ε) | bᵤ(tₓ) | Scan bₖ | Search b₀→bₖ₋₁ | |
| Existing | Adding | bₗ(t_{y}) | bᵤ(t_{y} + Δ) | Scan b₀, bₖ | | |
| Delta | Removing | bₗ(tₓ − ε) | bᵤ(tₓ + Δ) | | Search b₀→bₖ | Include b₁→bₖ₋₁ |

The query process includes two steps. In the first step, the T-Graph engine acquires the bucket candidates. TABLE 3-b shows the start bucket and the end bucket of the bucket candidates. In the second step, the edges inside each bucket of the bucket candidates are checked using a sequential scan, an upper-edge/lower-edge query, or skip operations. In TABLE 3-b, scan, search, and include are used to represent different operations. Let B be the size of each bucket. Scan takes O(B) time while search costs O(log B) and include has constant time. TABLE 3-b shows the operations that each bucket of the bucket candidates should conduct.

In TABLE 3-b, [tₓ, t_{y}] is the query time range, Δ is the shifting time, and ε is the maximal edge time duration. Bucket candidates are formalized from b₀ to bₖ, where k is a variable based on the different queries and k′ is an intermediate value for the existing snapshot where b′ₖ is bᵤ(tₓ). TABLE 3-b shows, in real-world temporal graphs, the operations a bucket should usually conduct. According to TABLE 3-b, most buckets in the bucket candidates conduct search operations which takes the logarithmic time of the bucket size. Therefore, the T-Graph engine 200 is efficient for duration snapshots and delta retrieval.

The temporal single source shortest path (T-SSSP) method can be applied on any kind of temporal duration snapshot with any time duration. The T-SSSP method is shown in TABLE 4.

TABLE 4
Algorithm 1: T-SSSP Algorithm

| | Input: G(V, E), [tₓ, t_{y}], Source Node u |
|---|---|
| | Output: ∀ v ε V \ u, et(v) |
| 1 | Initialize et(u) = tₓ; |
| 2 | Initialize et(v) = infinity; |
| 3 | Retreive duration snapshot in [tₓ, t_{y}]; |
| 4 | repeat |
| 5 | \| \| foreach e(u, v) ε duration snapshot do |
| 6 | \| \| \| if tₛ(e) ≦ et(u) then |
| 7 | \| \| \| if et(u) + τ(e) < et(v) then |
| 8 | \| \| \| \| et(v) = et(u) + τ(e) // Update |
| 9 | \| \| else |
| 10 | \| \| \| if tₛ(e) + τ(e) < et(v) then |
| 11 | \| \| \| \| et(v) = tₛ(e) + τ(e) // Update; |
| 12 | \| \| end |
| 13 | \| end |
| 14 | until No Update; |

The input of the T-SSSP method is a temporal graph, a time duration, and a source node. The outputs are the minimal ending traversal times et(v) to finish traversing at each node. The method can work on any order of edges being checked and not only for the partial order edge list 205. From line 5 to line 13 in TABLE 4, the for loop can be paralleled perfectly. There is no need for a reading/writing lock on any et(v) because the method can always converge.

In one embodiment, due to the large amount of storage space for large-scale real-world temporal graph data, the temporal data can be kept on-disk for a single node machine with limited memory.

During the duration snapshots query 202 and duration deltas query 203, the bucket index 204 can be loaded into the memory 108. The edges in the bucket candidates should then be checked. However, the memory 108 may not be large enough for all of the bucket candidates when the query time range is large. In one embodiment, under such situations, the bucket candidates are loaded, chunk by chunk. The bucket cannot by split into different chunks, so the bucket size is also bounded by the memory 108 size.

Additionally shown in FIG. 2 is a temporal path 201. The temporal path 201 is a sequence of traversable edges in which, for any two consecutive edges, a destination node of a previous edge is the same as a source node of a later edge, and a starting traversal time of the later edge cannot be earlier than an ending traversal time of the previous edge. The edges have a starting time, an ending time, and a transmission duration. Let tₛ(e) be the starting time and tₑ(e) be the ending time of an edge e in which the source node is u and the destination node is v. Let τ(e) be the transmission duration of edge e. Edge e is traversable if and only if the starting traversable time at u is st(u)≧tₛ(e) and the ending traversal time at v is et(v)=st(u)+τ(e)≦tₑ(e).

A T-SSSP finding problem is a temporal path query in the T-Graph engine 200. The path with the earliest arrival time is used as the temporal shortest path. In the T-SSSP problem, there are three inputs: a temporal graph G_{T}(V, E_{T}); a source node u; and a time duration [tₓ,t_{y}]. The outputs are et(v) for all v∈V\u, where et(v) is a minimal ending traversal time at node v from node u via a valid temporal path.

The T-Graph engine forms indexing methods for snapshots and deltas and these methods combine the index 204 on top of the bucket sequence and the ordered edges inside each bucket to optimize the time-locality query. At the bucket level, the index on the bucket sequence 204 is built. There are two types of queries on the bucket: a lower-bound bucket query; and an upper-bound bucket query. The lower-bound query is to return, for a given time t, bucket bₗ(t), where tₛ(bₗ)≦t≦tₑ(bₗ) and t>tₑ(bₗ₋₁). Namely, in the sequence of buckets, the lower-bound bucket is the leftmost bucket which includes t. At the other side, the upper-bound bucket query is to return, for a given time t, bucket bᵤ(t), where tₛ(bᵤ)≦t≦tₑ(bᵤ) and t<tₛ(bᵤ₊₁). Namely, the upper-bound bucket is the rightmost bucket which includes t. Now described is an improved b+ tree index for the lower-bound bucket query and the upper-bound bucket query. The time complexities of the upper-bound bucket query and lower-bound bucket query are both O(log n/k), where n is number of edges and k is the size of the bucket. Space complexity of the index structure on the bucket sequence is O(n/k), which can be very small. For example, it has been shown that, for temporal graphs with a billion edges, the actual graph data requires around 16 GB of space to store while the index structure can only take up around 100 KB of space. Such small storage overhead of indexing is critical to any big (graph) data oriented applications, such as travel planning, network routing, social networks, and system security.

Advantageously, since edges inside each bucket are ordered based on edge ending time, it is not necessary to build any indexes inside the bucket. This can result in a large amount of space being saved for indexing. Additionally, inside the bucket, two kinds of queries are needed: an upper-edge query; and a lower-edge query. The upper-edge query, given a time t for a bucket bₖ, is to return all edges inside bₖ with an ending time larger or equal to t. The lower-edge query is to return all edges inside bₖ with an ending time less than or equal to t. Such a query can be achieved by using a modified binary search. For each bucket, a binary search is conducted to find the minimal time and the maximal time, which can be no lesser or larger than the query time. The complexity of both the upper-edge query and the lower-edge query is O(log k), where k is the size of the bucket.

For temporal duration snapshots and deltas retrieval, no more than three upper-bound bucket queries or lower-bound bucket queries are needed to be conducted. However, a series of upper-edge or lower-edge queries, which are much more efficient, are needed.

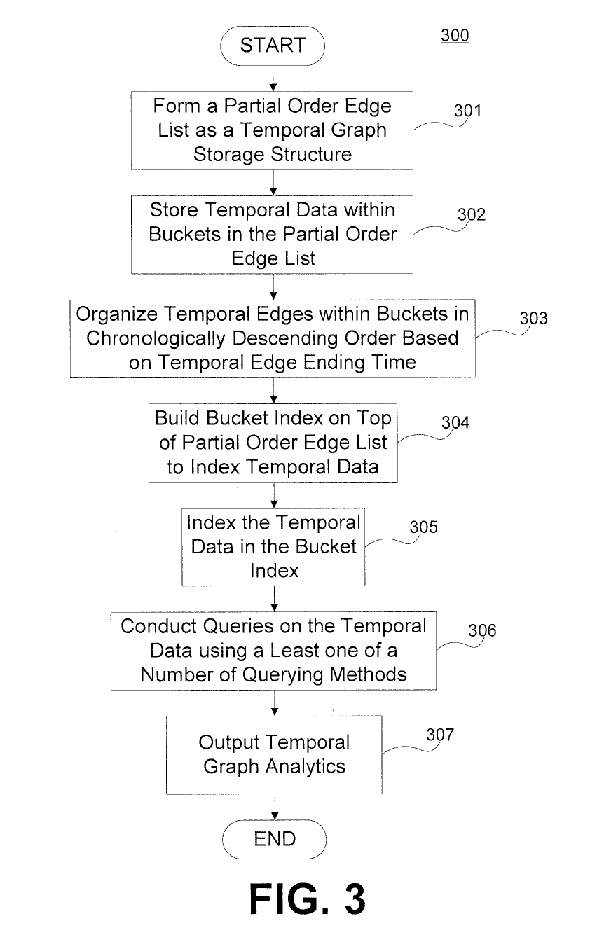

In FIG. 3, a process 300 of the T-Graph engine of FIG. 1 is shown.

In Step 301, the T-Graph engine 200 forms a partial order edge list 205. The partial order edge list 205 functions as a temporal graph storage structure 205 and has a set of buckets.

In Step 302, temporal data is stored within the partial order edge list 205. The temporal data includes respective data segments implemented using temporal graph edges. Each of these temporal edges has both a start time and an end time associated therewith. The temporal edges are housed in the buckets within the partial order edge list 205 and are not indexed.

In Step 303, the edges are ordered within the buckets in the partial order edge list 205 in chronologically descending order based on the ending time tₑ(e) of the edges. This type of ordering of the edges is beneficial in that, with this ordering scheme, it is not necessary to build any index inside the buckets. This has the capability of saving a very large amount of space for indexing. However, in other embodiments, a chronologically ascending order can also be used with similar attendant benefits.

In Step 304, the T-Graph engine 200 forms a bucket index 204 on top of the partial order edge list 205. This bucket index 204 can efficiently conduct all proposed time-locality queries on temporal graphs.

In Step 305, the temporal data within the partial order edge list 205 is indexed within the bucket index 204. During this process, the T-Graph engine forms indexing methods for snapshots and deltas. These methods combine the bucket index 204 and ordered edges inside each bucket. This optimizes a time-locality query.

In Step 306, the T-Graph engine conducts at least one type of query on the temporal data using at least one of a number of querying methods. This process can encompass two steps. In the first step, bucket candidates are acquired by the T-Graph engine. In the second step, using a sequential scan, an upper-edge/lower-edge query, or skip operations, edges inside each bucket of the bucket candidates are checked. Referring back to TABLE 3-b, with B being the size of each bucket, scan takes O(B) time while search costs O(log B) and include has constant time.

In Step 308, after the queries are performed, the corresponding temporal graph analytics are output.

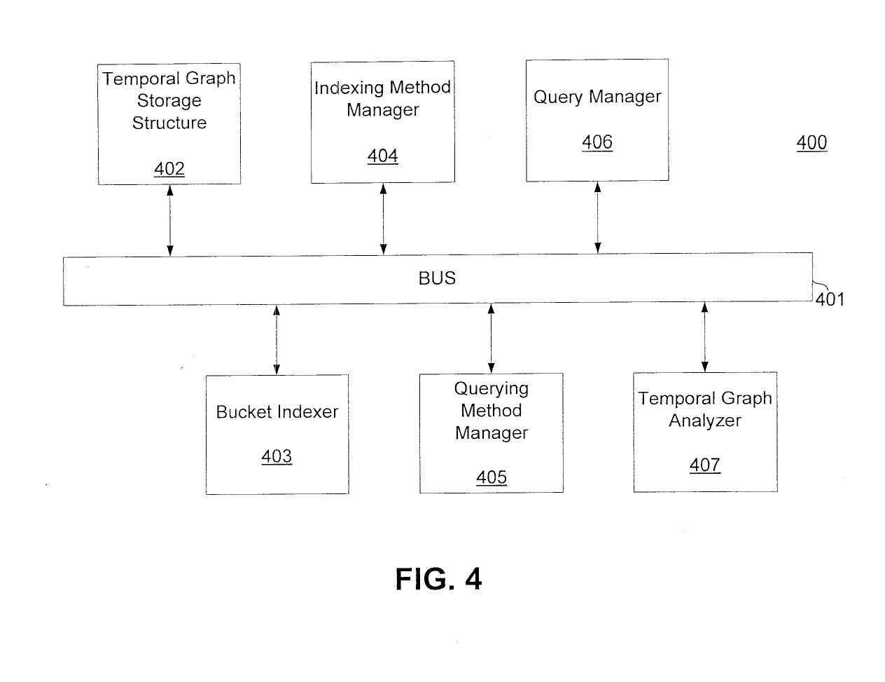

Referring now to FIG. 4, with continued reference to FIGS. 1-3, an exemplary system 400 for temporal graph analytics using a lightweight T-Graph engine is illustratively depicted in accordance with an embodiment of the present principles.

While many aspects of system 400 are described in singular form for the sake of illustration and clarity, the same can be applied to multiple ones of the items mentioned with respect to the description of the system 400. For example, while a single temporal graph storage structure 402 is illustratively depicted, more than one temporal graph storage structure 402 may be used in accordance with the teachings of the present principles while maintaining the spirit of the present principles. Moreover, it is appreciated that the temporal graph storage structure 402 is but one aspect involved with system 400 than can be extended to plural form while maintaining the spirit of the present principles.

The system 400 may include a bus 401, a temporal graph storage structure 402, a bucket indexer 403, an indexing method manager 404, a querying method manager 405, a query manager 406, and a temporal graph analyzer 405 according to various embodiments of the present principles.

In one embodiment, the temporal graph storage structure 402 may be implemented and deployed to all participating hosts (e.g., systems) in an enterprise for storage structures for storing temporal data and housing buckets. The temporal graph storage structure 402 may be represented by a partial order edge list 205. Furthermore, in the temporal graph storage structure 402, each bucket may have the same storage space but the lengths of time duration for different buckets may not be equal. Additionally, every edge may be allocated into exactly one bucket. The edges are ordered within the buckets in chronologically descending order based on the ending time of the edges.

In one embodiment, a bucket indexer 403 may index the edges within the temporal graph storage structure 402 according to the present principles. In one embodiment, the bucket indexer 403 builds a bucket index 204 on top of the partial order edge list 205.

In one embodiment, an indexing method manager 404 may be employed to form indexing methods for indexing temporal data within the bucket index 204 according to the present principles. These methods combine the bucket index 204 on top of a bucket sequence and ordered edges inside each bucket. In one embodiment, the indexing method manager 404 forms indexing methods for snapshots and deltas.

In one embodiment, a querying method manager 405 may be employed to determine which one or more querying methods are to be used while performing one or more types of queries on the temporal data according to the present principles. The querying method manager 405 may acquire bucket candidates. In one embodiment, a query manager 406, according to the present principles, performs duration snapshots queries, duration deltas queries, and temporal path queries. The query manager 406 may check edges inside each of the bucket candidates using a sequential scan, an upper-edge/lower-edge query, or skip operations.

In one embodiment, after the query manager 406 performs queries, a temporal graph analyzer 407 performs temporal graph analytics and outputs a temporal graph.

It should be understood that embodiments described herein may be entirely hardware or may include both hardware and software elements, which includes but is not limited to firmware, resident software, microcode, etc. In a preferred embodiment, the present invention is implemented in hardware.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Referring further to FIG. 1, the temporal duration delta is a basic building block of temporal graph analytics, because many analytics consider graph changes rather than the graph status. These changes can be, for example, capturing changes on edge importance, incrementally modifying subgraph topology, and monitoring network flow dynamics. It is inefficient to use temporal duration snapshot retrieval methods for temporal duration delta query problems, since the temporal duration deltas often include much fewer edges compared to the snapshots. To generate two snapshots and compare them is expensive, especially when the two snapshots have time overlaps. Therefore, temporal duration delta retrieval requires another efficient solution.

Since the temporal duration delta describes the changes between two temporal duration snapshots, let the time duration of two temporal duration snapshots be [tₓ, t_{y}] and [tₓ+Δ, t_{y}+Δ]. Notice that it is required that the lengths of the two time durations be the same because, if a snapshot span a longer time range, it usually includes more edges. This would be meaningful when two snapshots are comparable. Also, when two snapshots have time overlaps, this can capture the changes on the graph along with time. Therefore, Δ≦t_{y}−tₓ.

The temporal duration delta includes two different types of delta: adding deltas; and removing deltas. For two temporal duration snapshots, S₁ with time duration [tₓ, t_{y}] and S₂ with time duration [tₓ+Δ, t_{y}+Δ], the temporal edges in S₂, but not in S₁, belong to the adding deltas, while temporal edges in S₁, but not in S₂, belong to the removing deltas. The temporal duration snapshots S₁ and S₂ can be one of a covering snapshot, a persisting snapshot, and an existing snapshot, but S₁ and S₂ should be the same type of temporal duration snapshot.

The query problem of temporal duration delta retrieval is defined thusly. For a given temporal graph G_{T}=(V, E_{T}), given the time duration [tₓ, t_{y}] and a shifting time Δ as inputs, the temporal edges which represent the temporal duration delta (adding delta or removing delta or both) are returned for one of the covering snapshot, the persisting snapshot, and the existing snapshot.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method, comprising:
storing, in a memory, temporal data for a temporal graph using a temporal graph storage structure having a set of buckets, the temporal data stored in the buckets including respective data segments implemented using graph edges, each of the graph edges having a start time and an end time associated therewith;
forming, by a processor, an index that categorizes the graph edges based on the end times of the graph edges;
positioning, by the processor, the graph edges within respective ones of the buckets for storage using the index such that the graph edges are positioned in the respective ones of the buckets in a chronological order that is based on the end times; and
accessing, by the processor, the temporal graph storage structure using the index responsive to a temporal graph query.

2. The method of claim 1, wherein each of the buckets in the set uses respectively different lower bounds and upper bounds on the start times of the graph edges in order to partition the graph edges into the respective ones of the buckets.

3. The method of claim 2, wherein, subsequent to graph edge partitioning into the respective ones of the buckets, any of the graph edges in each of the respective ones of the buckets are arranged in a chronologically descending order that is based on the end times of the graph edges.

4. The method of claim 2, wherein a modified b+ tree index is used to implement the lower bounds and the upper bounds.

5. The method of claim 1, further comprising processing at least one temporal duration snapshot query by forming at least one temporal duration snapshot, the at least one temporal duration snapshot including at least one of a covering snapshot, a persisting snapshot, and an existing snapshot, wherein:
all graph edges in the covering snapshot have start times and end times within a given timeframe;
all graph edges in the persisting snapshot are active during the entire given timeframe; and
all graph edges in the existing snapshot are active during at least a portion of the given timeframe.

6. The method of claim 5, further comprising acquiring at least one consecutive sequence of buckets that includes a set of candidate graph edges in the temporal duration snapshot and verifying that each graph edge in the sequence belongs to the temporal duration snapshot.

7. The method of claim 5, further comprising processing at least one temporal duration delta query based on at least one difference between two temporal duration snapshots.

8. The method of claim 5, further comprising processing at least one temporal path query by forming at least one temporal path that includes a sequence of at least some of the graph edges wherein, for any two consecutive graph edges in the sequence, a destination node for a previous graph edge is the same as a source node of a later graph edge.

9. The method of claim 5, further comprising processing a temporal single source shortest path query by determining a path with an earliest arrival time as a temporal shortest path for use in responding to the temporal single source shortest path query.

10. The method of claim 9, further comprising, during the temporal single source shortest path query, inputting a temporal graph, a source node, and a time duration, and outputting a minimal ending traversal time at a subsequent node with respect to the source node through a valid temporal path.

11. A system, comprising:
a memory for storing temporal data for a temporal graph using a temporal graph storage structure having a set of buckets, the temporal data stored in the buckets including respective data segments implemented using graph edges, each of the graph edges having a start time and an end time associated therewith; and
a processor configured to:
form an index that categorizes the graph edges based on the end times of the graph edges;
position the graph edges within respective ones of the buckets for storage using the index such that the graph edges are positioned in the respective ones of the buckets in a chronological order that is based on the end times; and
access the temporal graph storage structure using the index responsive to a temporal graph query.

12. The system of claim 11, wherein each of the buckets in the set uses respectively different lower bounds and upper bounds on the start times of the graph edges in order to partition the graph edges into the respective ones of the buckets.

13. The system of claim 12, wherein, subsequent to graph edge partitioning into the respective ones of the buckets, any of the graph edges in each of the respective ones of the buckets are arranged in a chronologically descending order that is based on the end times of the graph edges.

14. The system of claim 12, wherein a modified b+ tree index is used to implement the lower bounds and the upper bounds.

15. The system of claim 11, wherein the processor is further configured to process at least one temporal duration snapshot query by forming at least one temporal duration snapshot, the at least one temporal duration snapshot including at least one of a covering snapshot, a persisting snapshot, and an existing snapshot, wherein:
all graph edges in the covering snapshot have start times and end times within a given timeframe;
all graph edges in the persisting snapshot are active during the entire given timeframe; and
all graph edges in the existing snapshot are active during at least a portion of the given timeframe.

16. The system of claim 15, wherein the processor is further configured to acquire at least one consecutive sequence of buckets that includes a set of candidate graph edges in the temporal duration snapshot and verify that each graph edge in the sequence belongs to the temporal duration snapshot.

17. The system of claim 15, wherein the processor is further configured to process at least one temporal duration snapshot query based on at least one difference between two temporal duration snapshots.

18. The system of claim 17, wherein the processor is further configured to process at least one temporal path query by forming at least one temporal path that includes a sequence of at least some of the graph edges wherein, for any two consecutive graph edges in the sequence, a destination node for a previous graph edge is the same as a source node of a later graph edge.

19. The system of claim 15, wherein the processor is further configured to process a temporal single source shortest path query by determining a path with an earliest arrival time as a temporal shortest path for use in responding to the temporal single source shortest path query.

20. The system of claim 19, wherein, during the temporal single shortest path query, the processor is further configured to input a temporal graph, a source node, and a time duration, and output a minimal ending traversal time at a subsequent node with respect to the source node through a valid temporal path.
